(19) United States
(12) Patent Application Publication
(10) Pub. No.: US 2021/0394993 A1
(43) Pub. Date: Dec. 23, 2021

(54) Thermal Liner and Thermal Container Comprising Same

(71) Applicant: Cascades Canada ULC, Montreal (CA)

(72) Inventors: Matieu Jacques, Kingsey Falls (CA); Simon Provencher, Candiac (CA)

(21) Appl. No.: 17/351,670

(22) Filed: Jun. 18, 2021

Related U.S. Application Data
(60) Provisional application No. 63/040,793, filed on Jun. 18, 2020.

(51) Int. Cl. B65D 81/38; B32B 3/12; B32B 29/00

(52) U.S. Cl. CPC B65D 81/3823; B32B 3/12; B32B 29/005; B32B 2250/26; B32B 2307/304; B32B 2307/7265; B32B 2307/7246; B32B 2250/40

(57) ABSTRACT

The present disclosure concerns a thermal liner comprising an inner member comprising two sheets and a core sandwiched between said two sheets, the core comprising a geometrically patterned structure extending transversally between said two sheets; an inner ply covering at least partially the inner member; and an outer ply covering at least partially the inner ply. The outer ply is unattached to the inner ply at least along a section thereof so as to define therewith a ply-delimited air circulation gap inbetween. It concerns also a thermal container comprising a thermal liner assembly comprising such a thermal liner and configurable into an operative configuration defining an inner chamber.

### CROSS REFERENCE TO RELATED APPLICATIONS

The present application claims priority from U.S. provisional patent application No. 63/040,793, filed on Jun. 18, 2020, and entitled “THERMAL LINER AND THERMAL CONTAINER COMPRISING SAME”, the disclosure of which is hereby incorporated by reference in its entirety.

### TECHNICAL FIELD

The technical field relates to thermal containers, and more particularly to thermal liners for containers and to thermal containers including one or more thermal liners.

### BACKGROUND

It is known in the art to provide a container with an inner thermal liner in order to define a thermal container. For example and without being limitative, such thermal containers can be used for packing perishable goods along with a refrigerant such as ice, frozen gel packs, dry ice or the like, to maintain the perishable goods in a refrigerated state for temporary storage and/or shipping thereof.

Numerous material which offer good thermal insulation properties can be used in the construction of the thermal liners. For example and without being limitative, such materials include polystyrene, polyurethane foam, or the like. However, in many cases, such materials do not allow recycling thereof, once the thermal container has been used, and must be disposed of through landfill or the like, which is undesirable.

In order to alleviate this problem, it is known to manufacture thermal liners including foldable cellulosic fiber-based thermal liners with a single layer of corrugated and/or honeycomb material separating outer sheets. Known cellulosic fiber-based thermal liners and corresponding thermal containers however also tend to suffer from several drawbacks. For example and without being limitative, in many cases the thermal protection properties of the cellulosic fiber-based thermal liners and the resulting thermal containers have proved unsatisfactory to maintain the goods in a refrigerated state for sufficient time periods.

In view of the above, there is a need for a thermal liner and a thermal container comprising the thermal liner which would be able to overcome or at least minimize some of the above-discussed prior art concerns.

### BRIEF SUMMARY

It is therefore an aim of the present invention to address the above-mentioned issues.

According to a general aspect, there is provided a thermal liner comprising an inner member comprising two sheets and a core sandwiched between said two sheets, the core comprising a geometrically patterned structure extending transversally between said two sheets; an inner ply covering at least partially the inner member; and an outer ply extending outwardly and covering at least partially the inner ply. The outer ply is unattached to the inner ply at least along a section thereof so as to define therewith a ply-delimited air circulation gap inbetween.

According to another general aspect, there is provided a thermal liner comprising: an inner member having a volume Vp and comprising two sheets and a core sandwiched between said two sheets, the core comprising a geometrically patterned structure extending transversally between the two sheets; an inner ply comprising a cellulosic fiber-based sheet and covering at least partially the inner member and delimiting a volume Vi to contain the inner member; and an outer ply comprising a cellulosic fiber-based sheet and covering at least partially the inner ply and delimiting a volume Vo to contain the inner member surrounded by the inner ply. The volume Vo is greater than the volume Vi and the volume Vi is greater than the volume Vp to provide an inner air circulation gap between the inner member and the inner ply and a ply-delimited air circulation gap between the inner ply and the outer ply.

In another aspect, each one of the inner and outer plies has a surface area, and wherein the surface area of the outer ply is greater than the surface area of the inner ply.

In another aspect, at least one of the inner and outer plies has a substantially tubular shape.

In another aspect, the inner ply forms an inner bag at least partially delimiting an inner member-containing cavity.

In another aspect, the outer ply forms an outer bag at least partially delimiting an inner bag-containing cavity.

In another aspect, at least one of the inner and outer plies comprises a cellulosic fiber-based sheet.

In another aspect, at least one of the inner and outer plies comprises at least one of liquid and vapor resistant barriers.

In another aspect, at least one of the inner and outer plies comprises a reflective surface.

In another aspect, said geometrically patterned structure is formed by cellulosic fiber-based walls extending transversally between said two sheets and wherein said geometrically patterned structure comprises a honeycomb structure defining a grid of polygonal open-ended core cells.

In another aspect, the thermal liner is configurable into a C-shaped configuration and is engageable with a similar thermal liner configured in the C-shaped configuration in order to define therewith an inner chamber.

In another aspect, the thermal liner comprises one or more additional and intermediate plies extending at least partially between the inner and outer plies.

In another aspect, at least one of said one or more additional and intermediate plies is spaced apart from at least one of the outer and inner plies at least along a section thereof so as to separate the ply-delimited air circulation gap into a plurality of additional air circulation gaps.

According to another general aspect, there is provided a thermal container comprising: a container comprising: a container bottom wall; and four container side walls extending substantially perpendicularly from the container bottom wall; and a thermal liner assembly insertable into the container and comprising at least one thermal liner comprising: an inner member comprising two sheets and a core sandwiched between said two sheets, the core comprising a geometrically patterned structure extending transversally between said two sheets; an inner ply covering at least partially the inner member; and an outer ply covering at least partially the inner ply. At least one of the inner and outer plies comprises a cellulosic fiber-based sheet. The outer ply is spaced apart from the inner ply at least along a section thereof so as to define therewith a ply-delimited air circulation gap inbetween. The thermal liner assembly is configurable into an operative configuration defining an inner chamber delimited by a bottom wall, four side walls and a top wall. Each one of the bottom wall and the side walls of the thermal liner assembly is superposed respectively to the container bottom wall and the four container side walls when the thermal liner assembly is inserted in the container with the inner chamber being closeable at least by the top wall of the thermal liner assembly.

In another aspect, the thermal liner assembly comprises first and second thermal liners engageable with each other in order to define together the inner chamber when the thermal liner assembly is configured into the operative configuration.

In another aspect, the first and second thermal liners are configurable into a C-shaped configuration and are engageable with each other when in the C-shaped configuration in order to define together the inner chamber.

According to another general aspect, there is provided a thermal liner comprising an inner member; an inner ply surrounding at least partially the inner member; and an outer ply surrounding at least partially the inner ply. The outer ply is spaced apart from the inner ply at least along a section thereof so as to define therewith a ply-delimited air circulation gap inbetween.

According to another general aspect, there is provided a thermal liner comprising an inner member having a volume Vp; an inner ply surrounding at least partially the inner member and delimiting a volume Vi to contain the inner member; and an outer ply surrounding at least partially the inner ply and delimiting a volume Vo to contain the inner member surrounded by the inner ply. The volume Vo is greater than the volume Vi and the volume Vi is greater than the volume Vp to provide an inner air circulation gap between the inner member and the inner ply and a ply-delimited air circulation gap between the inner ply and the outer ply.

According to yet another general aspect, there is provided a thermal container comprising: a container comprising: a container bottom wall; and four container side walls extending substantially perpendicularly from the container bottom wall; and a thermal liner assembly insertable into the container and comprising at least one thermal liner according to the present disclosure. The thermal liner assembly is configurable into an operative configuration defining a closed inner chamber delimited by a bottom wall, four side walls and a top wall. Each one of the bottom wall and the side walls of the thermal liner assembly is superposed respectively to the container bottom wall and the four container side walls when the thermal liner assembly is inserted in the container with the inner chamber being closed at least by the top wall of the thermal liner assembly.

### BRIEF DESCRIPTION OF THE DRAWINGS

FIG. 1 is a front perspective view of a thermal liner in accordance with a first embodiment;

FIG. 2 is a cross-section view of the thermal liner of FIG. 1;

FIG. 3 is a cross-section view of a thermal liner in accordance with a second embodiment, the thermal liner comprising an additional and intermediate ply;

FIG. 4 is a front perspective view of a thermal liner in accordance with a third embodiment, the thermal liner being configurable into a substantially C-shaped configuration;

FIG. 5 is a cross-section view of the thermal liner of FIG. 4 taken along cross-section lines 5-5 thereof when the thermal liner is configured into an extended configuration;

FIG. 6 is a top perspective view of a thermal container in accordance with a first embodiment, the thermal container comprising a container and first and second thermal liners of FIG. 4 inserted in the container and exposing an inner chamber defined thereby;

FIG. 7 is a front perspective view of a thermal liner in accordance with a fourth embodiment, an outer ply of the thermal liner comprising an outer reflective surface;

FIG. 8 is a top perspective view of a thermal container in accordance with a second embodiment, the thermal container comprising a container and first and second thermal liners of FIG. 7 being inserted in the container and exposing an inner chamber defined thereby;

FIG. 9 is a cross-section view of a thermal liner in accordance with a fifth embodiment, the thermal liner comprising an inner member and a plurality of plies covering partially the inner member; and

FIG. 10 is a cross-section view of the thermal liner of FIG. 9 taken along cross-section lines 10-10 thereof.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the thermal liner and the thermal container comprising the same and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

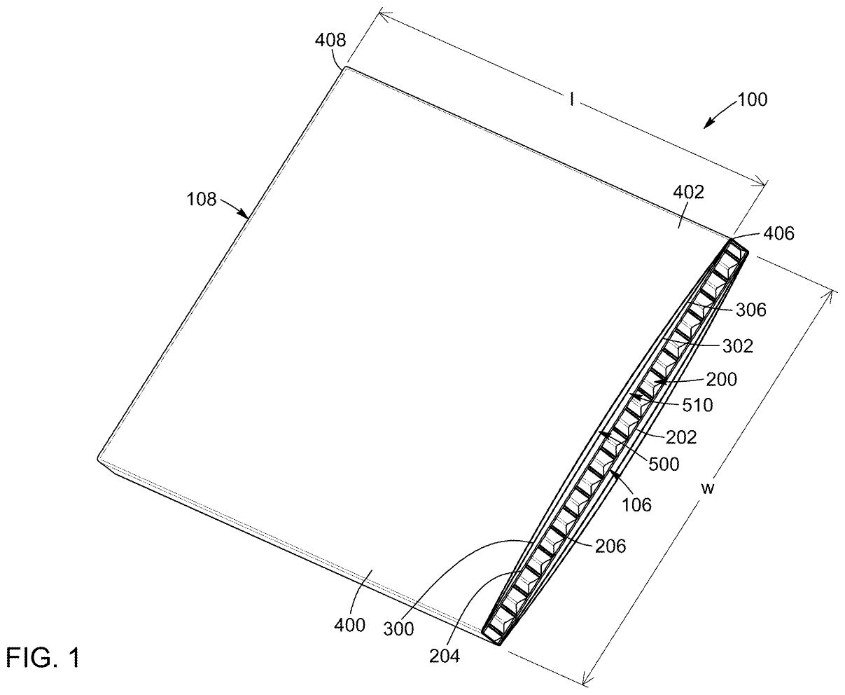

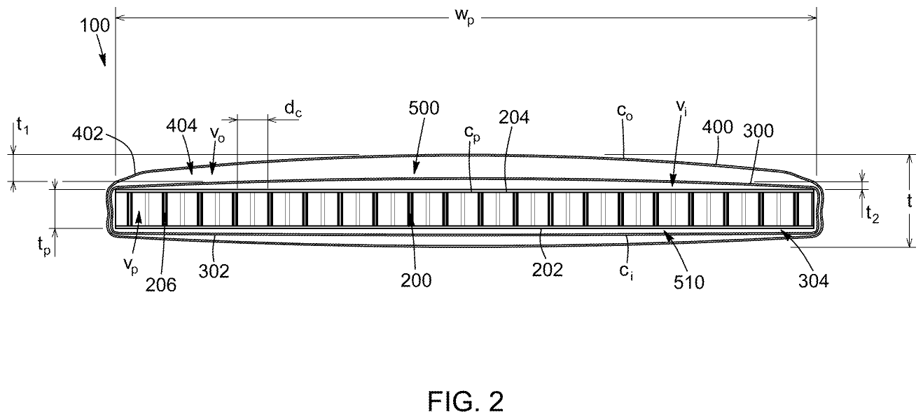

Referring now to the drawings, and more particularly to FIGS. 1 and 2, there is shown a thermal liner 100 in accordance with a first embodiment.

In the embodiment shown, the thermal liner 100 comprises an inner member 200 (or inner panel 200, in the embodiment shown). The thermal liner 100 further comprises an inner ply 300 covering (for instance surrounding) at least partially the inner panel 200, and an outer ply 400 extending outwardly and covering (for instance surrounding) at least partially the inner ply 300. The outer ply 400 is spaced apart from the inner ply 300 at least along a section thereof so as to define therewith a ply-delimited air circulation gap 500 inbetween. For instance, the outer ply is unattached to the inner ply at least along a section thereof.

It is thus understood that the outer ply is unbonded to the inner ply, so that the outer ply is distanceable (i.e., separable) from the inner ply along at least a section thereof. In other words, the outer ply extends at least over a section of the inner ply without being connected to (for instance without being attached or secured to) the section of the inner ply so as to at least partially delimit the ply-delimited air circulation gap inbetween. In still other words, the outer and inner plies can be moved apart from each other along at least sections thereof.

In the following description, the term ply refers to a layer or a plurality of layers laminated or secured together, such as a layer of cellulosic-based material (including a layer of paper).

In the following description, unless otherwise stated, the terms inner and outer relative to the inner and outer plies 300, 400 should be understood with respect to a core 206 of the inner panel 200.

In other words, the inner panel 200 has a panel volume Vp. The inner ply 300 surrounds at least partially the inner panel 200 and delimits a volume Vi to contain the inner panel 200. The outer ply 400 surrounds at least partially the inner ply 300 and delimits a volume Vo to contain the inner panel 200 at least partially surrounded by the inner ply 300. In the embodiment shown, the inner panel 200, the inner ply 300 and the outer ply 400 are shaped and dimensioned so that the volume Vo is greater than the volume Vi and the volume Vi is greater than the volume Vp to provide an inner air circulation gap 510 between the inner panel 200 and the inner ply 300 and the above-mentioned ply-delimited air circulation gap 500 between the inner ply 300 and the outer ply 400. In other words, each one of the inner and outer plies has a surface area, the surface area of the outer ply 400 being greater than the surface area of the inner ply 300.

For instance, the volume Vo at least partially delimited by the outer ply 400 is greater than about 100.5% of the volume Vi at least partially delimited by the inner ply 300. In another example, the volume Vo at least partially delimited by the outer ply 400 is greater than about 101% of the volume Vi at least partially delimited by the inner ply 300. In another example, the volume Vo at least partially delimited by the outer ply 400 is greater than about 102% of the volume Vi at least partially delimited by the inner ply 300. In another example, the volume Vo at least partially delimited by the outer ply 400 is greater than about 105% of the volume Vi at least partially delimited by the inner ply 300. In another example, the volume Vo at least partially delimited by the outer ply 400 is greater than about 110% of the volume Vi at least partially delimited by the inner ply 300. In yet another example, the volume Vo at least partially delimited by the outer ply 400 is greater than about 115% of the volume Vi at least partially delimited by the inner ply 300.

For instance, the volume Vo at least partially delimited by the outer ply 400 is greater than about 101% of the panel volume Vp. In another example, the volume Vo at least partially delimited by the outer ply 400 is greater than about 102% of the panel volume Vp. In another example, the volume Vo at least partially delimited by the outer ply 400 is greater than about 104% of the panel volume Vp. In another example, the volume Vo at least partially delimited by the outer ply 400 is greater than about 110% of the panel volume Vp. In another example, the volume Vo at least partially delimited by the outer ply 400 is greater than about 115% of the panel volume Vp. In yet another example, the volume Vo at least partially delimited by the outer ply 400 is greater than about 120% of the panel volume Vp.

For instance, the volume Vi at least partially delimited by the inner ply 300 is greater than about 100.5% of the panel volume Vp. In another example, the volume Vi at least partially delimited by the inner ply 300 is greater than about 101% of the panel volume Vp. In another example, the volume Vi at least partially delimited by the inner ply 300 is greater than about 102% of the panel volume Vp. In another example, the volume Vi at least partially delimited by the inner ply 300 is greater than about 105% of the panel volume Vp. In another example, the volume Vi at least partially delimited by the inner ply 300 is greater than about 110% of the panel volume Vp. In yet another example, the volume Vi at least partially delimited by the inner ply 300 is greater than about 115% of the panel volume Vp.

### Inner Member (or Inner Panel)

In the embodiment show, the inner panel 200 (or inner member 200) has first and second sheets 202, 204 and the above-mentioned core 206 sandwiched between the first and second sheets 202, 204. In the embodiment shown, the core 206 of the inner panel 200 comprises a geometrically patterned structure formed by cellulosic fiber-based walls extending transversally between the first and second sheets 202, 204 (or inner and outer sheets 202, 204 considered with respect to an inner volume of a container in which the thermal liner 100 would be arranged). It is thus understood that the geometrically patterned structure is shaped and dimensioned to form a plurality of air gaps between the first and second sheets 202, 204 so as to provide heat insulation properties to the inner panel 200.

In the embodiment shown, the core 206 of the inner panel 200 separates the sheets 202, 204 and creates an array of cells therebetween at least partially delimiting the above-mentioned plurality of air gaps. In the embodiment shown, the geometrically patterned structure of the core 206 includes a plurality of cellulosic fiber-based structures extending between the sheets 202, 204. For example and without being limitative, in an embodiment, the plurality of cellulosic fiber-based structures are honeycomb structures (or honeycomb cells) formed by cellulosic fiber-based walls, such as Kraft paper walls or the like, extending transversely (for instance perpendicularly) between the sheets 202, 204. One skilled in the art will understand that, in alternative embodiments, other structures providing the array of cells between the sheets 202, 204 could also be provided.

In the course of the present document, the term “honeycomb structure” is understood to mean a three-dimensional geometrically patterned structure defining a grid of polygonal (for instance hexagonal) open-ended core cells and providing an enhanced strength for supporting and protecting loads. As will be easily understood, the honeycomb structure creates an air space as a result of the three-dimensional geometrically patterned structure.

In the embodiment shown, the inner panel 200 has an overall grammage comprised between about 100 g/m² and about 4000 g/m² (i.e., an overall basis weight comprised between about 20.5 lb/1000 ft² and about 820 lb/1000 ft²). In another embodiment, the overall grammage of the inner panel 200 is comprised between about 200 g/m² and about 2000 g/m² (i.e., the overall basis weight is comprised between about 41 lb/1000 ft² and about 410 lb/1000 ft²).

In the embodiment shown, as represented in FIG. 2, the inner panel 200 has a thickness tp comprised between about 0.375 in and about 3 in. In another embodiment, the thickness tp of the inner panel 200 is comprised between about ¾ in and about 2 in. In another embodiment, the thickness tp of the inner panel 200 is about 1 in.

In the embodiment shown, each of the cells created by the core 206 between the sheets 202, 204 has a diameter dc comprised between about ¼ in and about 1 in. In another embodiment, the diameter dc of the cells is comprised between about ¼ in and about ½ in. In another embodiment, the diameter dc of the cells is about ⅜ in.

In the embodiment shown, the core 206 has a basis weight comprised between about 5 lb/1000 ft² and about 750 lb/1000 ft² (i.e., a grammage comprised between about 24.4 g/m² and about 3,660 g/m²). In another embodiment shown, the basis weight of the core 206 is comprised between about 10 lb/1000 ft² and about 500 lb/1000 ft² (i.e., the grammage is comprised between about 48.8 g/m² and about 2,440 g/m²). In another embodiment, the basis weight of the core 206 is comprised between about 25 lb/1000 ft² and about 220 lb/1000 ft² (i.e., the grammage of the core 206 is comprised between about 122 g/m² and about 1,073 g/m²).

In the embodiment shown, at least one of the first and second sheets 202, 204 has a basis weight comprised between about 5 lb/1000 ft² and about 102 lb/1000 ft² (i.e., a grammage comprised between about 25 g/m² and about 500 g/m²). In another embodiment, the basis weight of said at least one of the first and second sheets 202, 204 is comprised between about 10 lb/1000 ft² and about 51 lb/1000 ft² (i.e., a grammage comprised between about 50 g/m² and about 250 g/m²). In another embodiment, the basis weight of said at least one of the first and second sheets 202, 204 is comprised between about 20.5 lb/1000 ft² and about 41 lb/1000 ft² (i.e., a grammage comprised between about 100 g/m² and about 200 g/m²). In yet another embodiment, the basis weight of said at least one of the first and second sheets 202, 204 is about 26 lb/1000 ft² (i.e., the grammage is about 127 g/m²).

It is appreciated that the shape, the configuration, and the features of the inner panel 200 can vary from the embodiment shown. It could for instance be conceived an inner panel having a core with a plurality of geometrically patterned structures, for instance separated from each other via a separation sheet. It could also be conceived an inner panel wherein at least one of the inner and outer sheets (for instance both of them) would comprise a metallized polymer film. It could also be conceived an inner panel wherein at least one of the inner and outer sheets (for instance both of them) would comprise at least one of liquid and vapor resistant barriers. For example and without being limitative, the liquid/vapor resistant barrier can be a polyethylene film, a polypropylene film, a water-based coating or the like.

It should also be understood that the present disclosure is not limited to an inner member having first and second sheets and a core with a geometrically patterned structure sandwiched between the first and second sheets. For instance and without being limitative, it could be conceived a thermal liner comprising an inner member—or inner panel or inner mat—that would be at least partially formed by a plurality of paper towels, absorbent paper, embossed cardboard, cellulosic fiber-based material and the like, or any combination thereof.

### Outer and Inner Plies

In the embodiment shown, at least one of the outer and inner plies 400, 300 includes a cellulosic fiber-based sheet, such as a Kraft paper sheet or the like.

The inner and outer plies 300, 400 could for instance be formed of two distinct plies, each of them having for instance a substantially tubular shape. It could also be conceived a roll, such as a cellulosic fiber-based material roll formed by a cellulosic fiber-based material sheet rolled around itself in a substantially loose way—so as to form one or more air circulation gaps between the superposed portions of the material sheet—and around the inner panel 200, wherein the inner and outer plies 300, 400 would be formed by portions of the rolled material. A longitudinal end portion of the material forming the roll could be secured—for instance glued—to the inner panel 200 (for instance to an outer surface thereof).

In an embodiment, at least one of the outer and inner plies 400, 300 can also include at least one of a liquid resistant barrier and a vapor resistant barrier. For example and without being limitative, in an embodiment, at least one of the outer and inner plies 400, 300 can include a liquid/vapor resistant film laminated to a cellulosic fiber-based sheet, such as a Kraft liner board paper or the like. For example and without being limitative, the liquid/vapor resistant film can be a polyethylene film, a polypropylene film or the like. In an alternative embodiment, at least one of the outer and inner plies 400, 300 can rather include a liquid/vapor resistant coating applied to the cellulosic fiber-based sheet. Numerous types of liquid/vapor resistant coating could be applied to the cellulosic fiber-based sheet. For example and without being limitative, coatings including aqueous dispersion of polymers or copolymers which are capable to provide the above mentioned properties could be used, such as Michem®Coat 81 and Michem®Coat 82 which comprise a styrene-butadiene copolymer; VaporCoat® 2200R from the company Michelman, the products Spectra-Guard™ 3007 BK and Spectra-Guard™ 3003 both from the company Spectra-kote Corp., Tribinder from the company Tri-Tex Co inc., and Aqualene® 5050 from Aqua Based Technologies which all are acrylic based products; ESACOTE® PU DP 170/N which comprise a polyurethane; or Cartabond® SMH Liquid from the company CLARIANT, which is a polyvinylalcohol based aqueous dispersion. In another alternative embodiment, at least one of the outer and inner plies 400, 300 can also include a liquid/vapor resistant film such as a polyethylene film or the like, without cellulosic fiber-based sheet.

In the embodiment shown, at least one of the inner ply 300 and the outer ply 400 has a basis weight comprised between about 5 lb/1000 ft² and about 40 lb/1000 ft² (i.e., a grammage comprised between about 24.4 g/m² and about 195.2 g/m²). In another embodiment, the basis weight of at least one of the inner ply 300 and the outer ply 400 is comprised between about 10 lb/1000 ft² and about 20 lb/1000 ft² (i.e., the grammage of at least one of the inner and outer plies is comprised between about 48.8 g/m² and about 97.6 g/m²). In yet another embodiment, the basis weight of at least one of the inner ply 300 and the outer ply 400 is about 15 lb/1000 ft² (i.e., the grammage of at least one of the inner and outer plies is about 73.2 g/m²).

In the embodiment shown, the grammage (or basis weight) of the outer ply 400 is substantially equal to the grammage (or basis weight) of the inner ply 300. It could also be conceived an outer ply having a grammage that would be smaller or greater than a grammage of the inner ply.

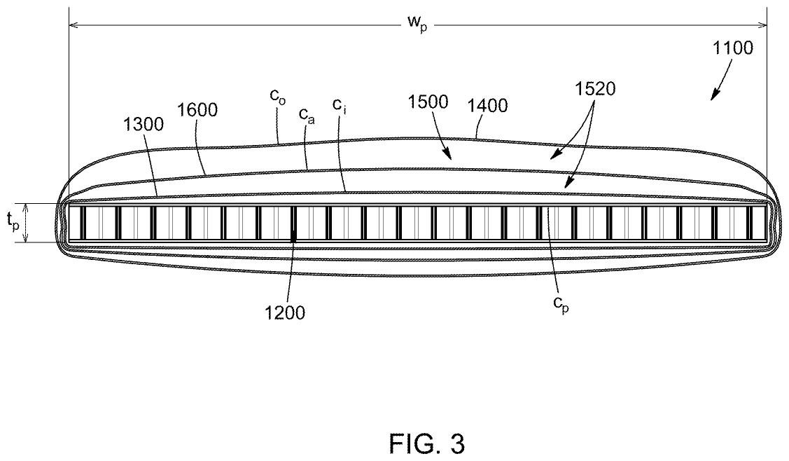

In the embodiment shown, as represented for instance in FIG. 3, considered in a plane substantially transversal (for instance substantially perpendicular) to the inner panel 200, each one of the inner and outer plies 300, 400 has a circumference ci and co, the circumference co of the outer ply 400 being greater than the circumference ci of the inner ply 300. For instance, the circumference co of the outer ply 400 is greater than about 101% of the circumference ci of the inner ply 300. In another embodiment, the circumference co of the outer ply 400 is greater than about 102% of the circumference ci of the inner ply 300. In another embodiment, the circumference co of the outer ply 400 is greater than about 105% of the circumference ci of the inner ply 300. In another embodiment, the circumference co of the outer ply 400 is greater than about 110° of the circumference ci of the inner ply 300. In another embodiment, the circumference co of the outer ply 400 is greater than about 120% of the circumference ci of the inner ply 300. In yet another embodiment, the circumference co of the outer ply 400 is greater than about 130% of the circumference ci of the inner ply 300.

In the embodiment shown, the circumferences ci, co of the inner and outer plies 300, 400 are greater than a circumference cp of the inner panel 200. In the embodiment shown, as represented for instance in FIG. 2, the circumference cp of the inner panel 200 corresponds to the double sum of the thickness tp and a width wp of the inner panel 200.

In the embodiment shown, the circumference ci of the inner ply 300 is greater than about 100.5% of the circumference cp of the inner panel 200. In another embodiment, the circumference ci of the inner ply 300 is greater than about 101% of the circumference cp of the inner panel 200. In another embodiment, the circumference ci of the inner ply 300 is greater than about 102% of the circumference cp of the inner panel 200. In another embodiment, the circumference ci of the inner ply 300 is greater than about 105% of the circumference cp of the inner panel 200. In another embodiment, the circumference ci of the inner ply 300 is greater than about 110% of the circumference cp of the inner panel 200. In yet another embodiment, the circumference ci of the inner ply 300 is greater than about 120% of the circumference cp of the inner panel 200.

As mentioned above, the surface area of the outer ply is greater than the surface area of the inner ply. For instance, the surface area of the outer ply is greater than about 102% of the surface area of the inner ply. In another embodiment, the surface area of the outer ply is greater than about 105% of the surface area of the inner ply. In another embodiment, the surface area of the outer ply is greater than about 110% of the surface area of the inner ply. In another embodiment, the surface area of the outer ply is greater than about 115% of the surface area of the inner ply. In yet another embodiment, the surface area of the outer ply is greater than about 120% of the surface area of the inner ply.

In the embodiment shown, the circumference co of the outer ply 400 is greater than about 101% of the circumference cp of the inner panel 200. In another embodiment, the circumference co of the outer ply 400 is greater than about 102% of the circumference cp of the inner panel 200. In another embodiment, the circumference co of the outer ply 400 is greater than about 105% of the circumference cp of the inner panel 200. In another embodiment, the circumference co of the outer ply 400 is greater than about 110% of the circumference cp of the inner panel 200. In another embodiment, the circumference co of the outer ply 400 is greater than about 120% of the circumference cp of the inner panel 200. In yet another embodiment, the circumference co of the outer ply 400 is greater than about 130% of the circumference cp of the inner panel 200.

In the embodiment shown, as represented for instance in FIGS. 1 and 2, at least one of the inner and outer plies 300, 400 has a substantially tubular shape. In the embodiment shown, the inner and outer plies 300, 400 both have a substantially tubular shape.

As presented in FIGS. 1 and 2, the inner ply 300 forms an inner bag 302 at least partially delimiting an inner panel-containing cavity 304 (or inner member-containing cavity 304) having the above-mentioned inner ply volume Vi. The outer ply 400 forms an outer bag 402 at least partially delimiting an inner bag-containing cavity 404 and having the above-mentioned outer ply volume Vo.

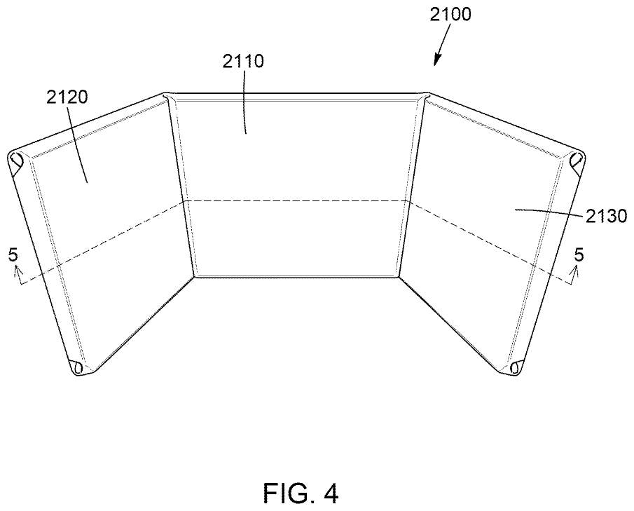

As represented, the inner and outer bags 302, 402 both have first and second lateral ends 306, 406, 408 forming at least partially first and second lateral ends 106, 108 of the thermal liner 100. The first and second lateral ends 106, 108 of the thermal liner 100 can be open, to allow air circulation between at least one of the ply-delimited air circulation gap 500 and the inner air circulation gap 510 and an exterior environment of the thermal liner 100. In another embodiment, at least one of the first and second lateral ends 106, 108 of the thermal liner 100 could be at least partially closed, for instance via adhesive tape arranged on an outer surface of the outer ply 400 or by any other suitable closing device. For instance, a lateral end portion of at least one of the inner and outer plies 300, 400 is folded on itself (as represented for instance in FIG. 4) in order to at least partially close at least one of the inner and outer bags 302, 402. In an embodiment, the lateral end portions of at least one of the inner and outer plies 300, 400 is sealed to substantially limit gas communication therethrough. When both lateral end portions are sealed, the inner and/or the outer plies 300, 400 define a closed bag surrounding the inner panel 200. In the embodiment shown, at least one of the inner and outer plies 300, 400 is arranged so that the corresponding one of the inner and outer bags 302, 402 is not closed in a fluid-tight manner (i.e., so that at least one of the ply-delimited air circulation gap 500 and the inner air circulation gap 510 is in fluid communication with the external environment of the thermal liner).

### Shape and Dimensions of the Thermal Liner

In the first embodiment shown in FIGS. 1 and 2, the thermal liner 100 has a substantially parallelepipedal shape and defines a width w, a length l and a thickness t.

In the embodiment shown, the width w of the thermal liner 100 is comprised between about 5 in and about 50 in. In another embodiment, the width w of the thermal liner 100 is comprised between about 5 in and about 30 in. In another embodiment, the width w of the thermal liner 100 is comprised between about 8 in and about 20 in. In another embodiment, the width w of the thermal liner 100 is comprised between about 10 in and about 15 in.

In the embodiment shown, the length l of the thermal liner 100 is comprised between about 10 in and about 80 in. In another embodiment, the length l of the thermal liner 100 is comprised between about 20 in and about 50 in. In another embodiment, the length l is comprised between about 30 in and about 40 in. In another embodiment, the length l is comprised between about 33 in and about 36 in.

### Dimensions of the Gaps

Considered in a plane substantially traversal to a plane of the inner panel 200, as represented in FIG. 2, at least a section of the ply-delimited air circulation gap 500 has a thickness t1 greater than about 10% of the thickness tp of the inner panel 200. In another embodiment, the thickness t1 of said section is greater than about 30% of the thickness tp of the inner panel 200. In another embodiment, the thickness t1 of said section is greater than about 50% of the thickness tp of the inner panel 200. In another embodiment, the thickness t1 of said section is greater than about 70% of the thickness tp of the inner panel 200. In yet another embodiment, the thickness t1 of said section is substantially equal to or greater than the thickness tp of the inner panel 200.

Considered in the same plane, at least a section of the inner air circulation gap 510 has a thickness t2 greater than about 5% of the thickness tp of the inner panel 200. In another embodiment, the thickness t2 of said section is greater than about 10% of the thickness tp of the inner panel 200. In another embodiment, the thickness t2 of said section is greater than about 20% of the thickness tp of the inner panel 200. In another embodiment, the thickness t2 of said section is greater than about 40% of the thickness tp of the inner panel 200. In another embodiment, the thickness t2 of said section is greater than about 60% of the thickness tp of the inner panel 200. In another embodiment, the thickness t2 of said section is greater than about 80% of the thickness tp of the inner panel 200. In yet another embodiment, the thickness t2 of said section is substantially equal to or greater than the thickness tp of the inner panel 200.

As represented in FIG. 2, the thickness t1, t2 of at least one of the ply-delimited air circulation gap 500 and the inner air circulation gap 510 can vary along a section thereof. For instance, the thermal liner 100 could be arranged so that, in some sections thereof, the inner ply 300 contacts the inner panel 200 (i.e., one of the first and second sheets 202, 204 thereof), while being spaced apart therefrom in other sections so as to define therewith the inner air circulation gap 510. For instance, the thermal liner 100 could be arranged so that, in some sections thereof, the outer ply 400 contacts the inner ply 300, while being spaced apart therefrom in other sections so as to define therewith the ply-delimited air circulation gap 500.

For instance and without being limitative, considered with respect to the inner volume—or good-receiving volume—of the container in which the thermal liner 100 would be arranged, as described below, an inner thickness of at least one of the ply-delimited air circulation gap 500 and the inner air circulation gap 510 would be greater than an outer thickness of the corresponding one of the ply-delimited air circulation gap 500 and the inner air circulation gap 510. In other words, dimensions of at least one of the ply-delimited air circulation gap 500 and the inner air circulation gap 510 could be greater on an inner side (or container inner volume-delimiting side) of the thermal liner 100 than on an outer side (or container wall-facing side) of the thermal liner 100.

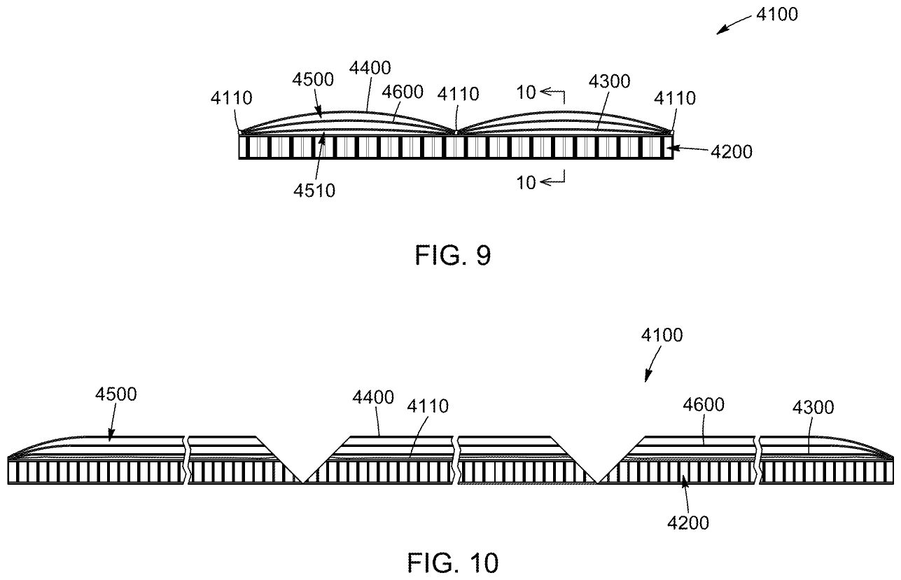

As best shown in FIGS. 9 and 10, it could also be conceived a thermal liner 4100 comprising an inner member 4200 (or inner panel 4200), an inner ply 4300 covering at least partially the inner panel 4200, and an outer ply 4400 covering at least partially the inner ply 4300. The outer ply 4400 is spaced apart from the inner ply 4300 (i.e., is unattached to the inner ply 4300) at least along a section thereof so as to define therewith a ply-delimited air circulation gap 4500 inbetween. An inner air circulation gap 4510 is also provided between the inner member 4200 and the inner ply 4300.

In the embodiment shown, the inner and outer plies 4300, 4400 cover only a portion of the inner member 4200 (i.e., are provided only on one of the sides of the thermal liner 4100). In the embodiment shown, no inner and outer plies are provided on the other side of the thermal liner 4100. It could also be conceived a thermal liner wherein, on the other side thereof, the inner and outer plies 4300, 4400 would contact each other (would be attached or connected to each other, i.e., would not be distanceable from each other) with the inner ply 4300 contacting the inner member 4200, with thus no inner air circulation gap or ply-delimited air circulation gap being provided on said other side.

For instance and without being limitative, considered with respect to the inner volume—or good-receiving volume—of a container in which the thermal liner 4100 would be arranged, as described below, an inner side of the thermal liner 4100 could comprise at least one of the ply-delimited air circulation gap 4500 and the inner air circulation gap 4510, while no ply-delimited air circulation gap or inner air circulation gap would be provided on an outer side of the thermal liner 4100.

As represented in FIGS. 9 and 10, one or more ply-securing straps or lines 4110 (for instance one or more lines or layers of glue) could be provided so as to at least partially secure together the inner member 4200, the inner ply 4300 and the outer ply 4400. More particularly, the ply-securing straps or lines 4110 separate the ply-delimited air circulation gap 4500 and the inner air circulation gap 4510 into a plurality of sub-air circulation gaps. In the embodiment shown, the ply-securing lines 4110 are substantially parallel to each other and extend substantially along a length of the thermal liner 4100.

It is appreciated that the shape, the configuration, the number and the location of the ply-securing lines 4110 can vary from the embodiment shown.

In the embodiment shown, the thermal liner 4100 further comprises an additional and intermediate ply 4600 extending at least partially between the inner and outer plies 4300, 4400 and surrounding at least partially the inner ply 4300. As detailed below with reference to FIG. 3, the additional ply 4600 is spaced apart from at least one of the outer ply 4400 and the inner ply 4300 at least along a section thereof so as to separate each section of the ply-delimited air circulation gap 4500 into a plurality (two, in the embodiment shown) of additional air circulation gaps 4520. In the embodiment shown, the additional ply 4600 also locally contacts the inner member 4200, the inner ply 4300 and the outer ply 4400 via the ply-securing straps or lines 4110.

In the embodiment shown, the inner and outer plies 300, 400 are shaped and dimensioned for at least sections of the outer ply 400 and the inner ply 300 and/or the inner ply 300 and the inner panel 200 to be kept mostly spaced-apart from each other. In other words, the inner and outer plies 300, 400 are shaped and dimensioned to be at least partially distanceable—or separable—from each other so as to at least partially delimit the ply-delimited air circulation gap inbetween. For instance, at least one of the inner and outer plies 300, 400 has rigidity properties allowing to maintain spaced-apart from each other the outer ply 400 and the inner ply 300 and/or the inner ply 300 and the inner panel 200 at least along a section thereof. In another embodiment, gap-maintaining material (for instance cellulosic fiber-based material, bubble wrap, paper towel, tissue paper, hand towel tissue and the like) is inserted between the outer and inner plies and/or between the inner ply and the inner member, so that at least sections of the outer ply 400 and the inner ply 300 and/or the inner ply 300 and the inner panel 200 to be kept spaced-apart from each other. For instance, the gap maintaining material could be at least partially secured (for instance glued) to at least one of the inner and outer plies and/or to the inner member.

It is appreciated that the shape, the configuration, and the respective location of the inner and outer plies 300, 400, as well as the shape and the dimensions of the thermal liner 100 can vary from the embodiment shown.

For instance, as represented in FIG. 3, it could be conceived a thermal liner 1100 comprising an inner panel 1200, an inner ply 1300 and an outer ply 1400. In the embodiment shown, the thermal liner 1100 further comprises one or more additional and intermediate plies 1600 (one additional and intermediate ply 1600, in the embodiment shown) extending at least partially between the inner and outer plies 1300, 1400 and surrounding at least partially the inner ply 1300.

In the embodiment shown, the additional ply 1600 is spaced apart from at least one of the outer ply 1400 and the inner ply 1300 at least along a section thereof so as to separate the ply-delimited air circulation gap 1500 into a plurality (two, in the embodiment shown) of additional air circulation gaps 1520.

In the embodiment shown, considered in a plane substantially transversal (for instance substantially perpendicular) to the inner panel 1200, as represented in FIG. 3, the additional ply 1600 has a circumference ca smaller than the circumference co of the outer ply 1400 and greater than the circumferences ci, cp of the inner ply 1300 and the inner panel 1200. The additional ply 1600 can be made of a material different from the material forming at least one of the inner and outer plies 1300, 1400 or from a material similar.

A thermal liner comprising more than three plies surrounding at least partially each other could also be conceived.

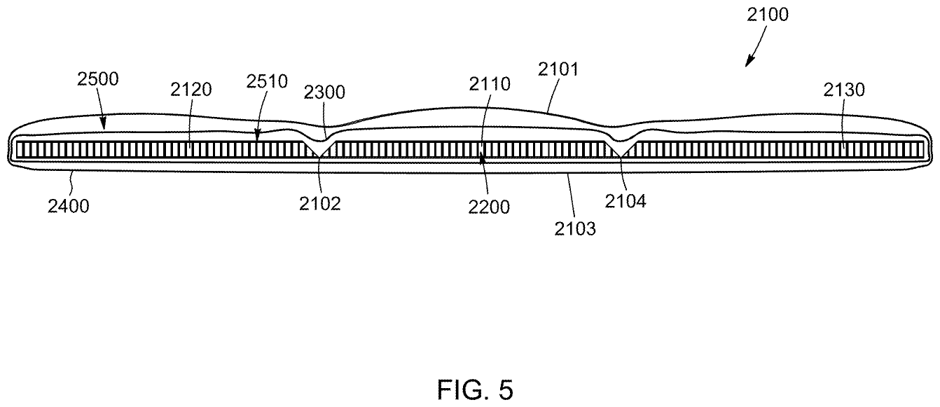

In another embodiment of the thermal liner 2100 represented in FIGS. 4 and 5, the thermal liner 2100 comprises an inner panel 2200 and inner and outer plies 2300, 2400. The thermal liner 2100 is configurable between an extended configuration (or substantially straight configuration), as represented in FIG. 5 where the thermal liner 2100 extends substantially straight, and an operative configuration, as represented in FIG. 4, where the thermal liner 2100 is configured into a substantially C-shaped configuration. In order to allow such folding of the thermal liner 2100 between the extended configuration and the operative configuration, in an embodiment, the thermal liner 2100 has V-shaped cuts 2102, 2104 (or crease lines) formed for instance in the inner panel 2200, thereby defining a plurality of planar panel sections (three planar panel sections 2110, 2120, 2130, in the embodiment shown).

In the embodiment shown and as best described below, the thermal liner 2100 is engageable with a similar thermal liner configured in the C-shaped configuration in order to define therewith a closable inner chamber.

In the embodiment shown in FIGS. 4 and 5, the thermal liner 2100 includes a central section 2110, a first end section 2120, and a second end section 2130. The thermal liner 2100 has a first V-cut 2102 (which could be replaced by a crease line in an alternative embodiment) defined between the central section 2110 and the first end section 2120, and a second V-cut 2104 (or crease line) defined between the central section 2110 and the second end section 2130. Each one of the first and second V-cuts 2102, 2104 extends between a first longitudinal edge and a second longitudinal edge opposed to the first longitudinal edge, with the first V-cut 2102 being substantially parallel to the second crease line 2104.

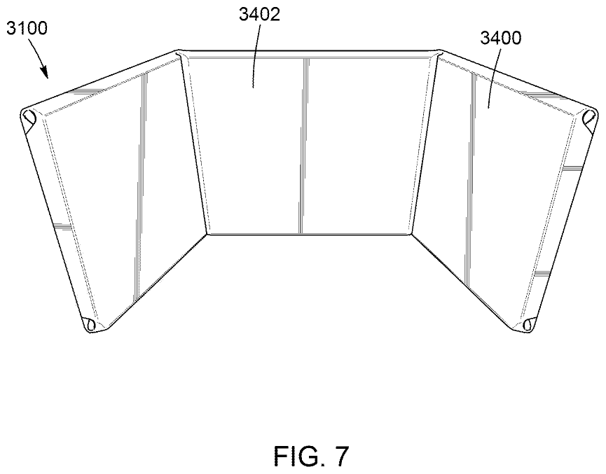

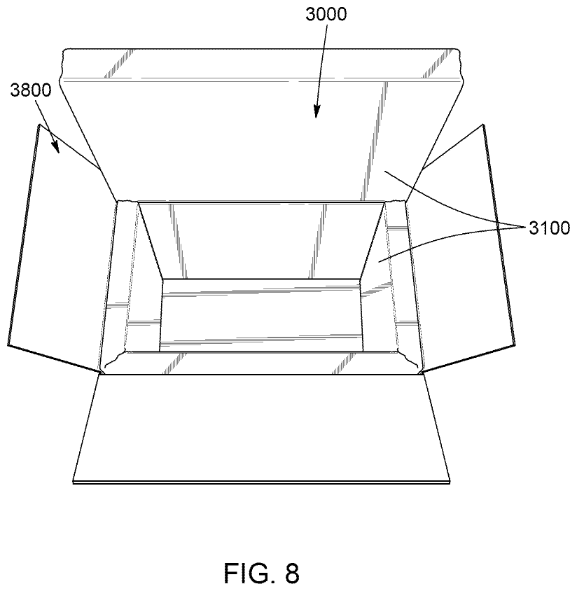

In another embodiment, as represented in FIGS. 7 and 8, the outer ply 3400 of the thermal liner 3100 includes a reflective outer surface 3402. For example and without being limitative, in an embodiment, the outer ply 3400 can include a metallized film, which can be laminated to a cellulosic fiber-based sheet, such as a Kraft liner board paper or the like. In an embodiment, the metallized film can include a film such as, for example and without being limitative, a polyethylene film, a polypropylene film or the like, onto which aluminum is vaporized. In an alternative embodiment, the outer ply 3400 can rather include a foil layer, or a layer of other material offering reflective characteristics, laminated to a plastic substrate, such as a polyethylene substrate, a polyester substrate or the like which can further be laminated to the cellulosic fiber-based sheet. One skilled in the art will also understand that, in other alternative embodiments, other combinations of materials, such as reflective coatings, offering reflective properties can also be used to provide the reflective surface 3402 of the outer ply 3400. In an embodiment, the reflective surface 3402 is an outer surface (e.g. the reflective film, layer or coating can line an outer surface of the outer ply 3400, i.e., a surface facing away from the inner panel of the thermal liner 3100). One skilled in the art will however understand that, in an alternative embodiment, the reflective surface can be an inner surface of the outer ply 3400.

In another embodiment, the inner ply and/or one of the additional plies of the thermal liner could also comprise at least one reflective surface, for instance comprising a metallized film, arranged on at least one of inner and outer surfaces therefrom.

In the embodiment shown, the outer ply 3400 comprises a metallized polymer film. In the embodiment shown, the metallized polymer film has a basis weight comprised between about 2 lb/1000 ft² and about 10 lb/1000 ft² (i.e., a grammage comprised between about 9.8 g/m² and about 49 g/m²). In another embodiment, the metallized polymer film has a basis weight comprised between about 3 lb/1000 ft² and about 5 lb/1000 ft² (i.e., a grammage comprised between about 14.6 g/m² and about 24.4 g/m²). In another embodiment, the metallized polymer film has a basis weight of about 3.5 lb/1000 ft² (i.e., a grammage of about 17.1 g/m²).

One skilled in the art will understand that, in an embodiment, the above-described reflective surface 3402 can operate as liquid/vapor resistant barrier (i.e., the reflective surface 3402 can provide the desired liquid/vapor resistant properties).

It is appreciated that the shape, the configuration, and the composition of the reflective surface can vary from the embodiment shown.

It is appreciated that the number and the composition of the inner and outer plies and the additional plies, comprising or not a reflective surface for instance at least partially formed of a metallized polymer film can vary from the embodiments shown.

For instance, it could also be conceived a thermal liner wherein at least one of the inner and outer plies would be at least partially formed of at least one of a corrugated material, an embossed material, a material comprising a geometrically patterned structure extending transversally between two sheets and the like.

### Thermal Container

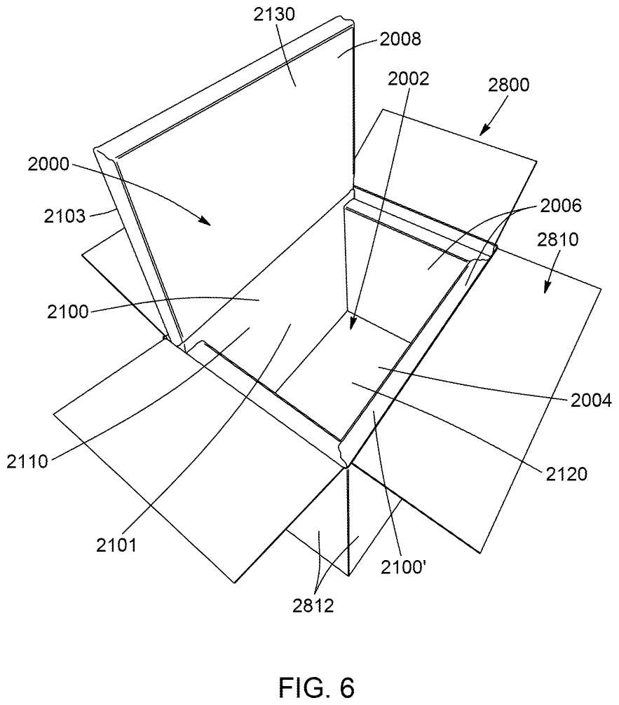

As represented for instance in FIG. 6, the present disclosure also concerns a thermal container 2800 comprising a container 2810 comprising a container bottom wall and four container side walls 2812 extending substantially perpendicularly from the container bottom wall. In the embodiment shown, the container 2810 has a substantially parallelepipedal shape.

The thermal container 2800 further comprises a thermal liner assembly 2000 insertable into an inner chamber of the container 2810 and comprising at least one thermal liner 2100 according to the present disclosure. The container 2810 has a container volume.

In the embodiment shown, the thermal liner assembly 2000 comprises first and second thermal liners 2100, 2100′ as represented in FIGS. 4 and 5.

The first and second thermal liners 2100, 2100′ comprise an inner side 2101 (or container inner volume-delimiting side 2101) and an opposed outer side 2103 (or container wall-facing side 2103). In the embodiment shown, at least one of the ply-delimited air circulation gap 2500 and the inner air circulation gap 2510 is at least partially provided on the inner side 2101 of the first and second thermal liners 2100, 2100′. In other words, at least one of the ply-delimited air circulation gap 2500 and the inner air circulation gap 2510 is arranged to at least partially surround the container volume of the container 2810 configured to receive, for instance, perishable goods and refrigerants.

The superposing of the thermal liners 2100, 2100′ onto the corresponding wall 2812 of the container 2810 might contribute to the formation and/or the stability of the dimensions of the portion of the at least one of the ply-delimited air circulation gap 2500 and the inner air circulation gap 2510 arranged on the container inner volume-delimiting side 2101 of the corresponding thermal liner 2100, 2100′. In other words, the arrangement of the thermal liners 2100, 2100′ within the container 2810 contributes to the formation and the stability of the dimensions of the sections of the ply-delimited air circulation gap 2500 and the inner air circulation gap 2510 arranged between the inner panel of the thermal liners 2100, 2100′ and the good-receiving inner volume of the container 2810.

For instance, the volume Vo at least partially delimited by the outer ply 2400 of one of the first and second thermal liners 2100, 2100′ is greater than about 5% of the container volume. In another embodiment, the volume Vo at least partially delimited by the outer ply 2400 of one of the first and second thermal liners 2100, 2100′ is greater than about 10% of the container volume. In another embodiment, the volume Vo at least partially delimited by the outer ply 2400 of one of the first and second thermal liners 2100, 2100′ is greater than about 15% of the container volume. In yet another embodiment, the volume Vo at least partially delimited by the outer ply 2400 of one of the first and second thermal liners 2100, 2100′ is greater than about 20% of the container volume.

For instance, the volume Vi at least partially delimited by the inner ply 2300 of one of the first and second thermal liners 2100, 2100′ is greater than about 2% of the container volume. In another embodiment, the volume Vi at least partially delimited by the inner ply 2300 of one of the first and second thermal liners 2100, 2100′ is greater than about 5% of the container volume. In another embodiment, the volume V1 at least partially delimited by the inner ply 2300 of one of the first and second thermal liners 2100, 2100′ is greater than about 10% of the container volume. In yet another embodiment, the volume Vi at least partially delimited by the inner ply 2300 of one of the first and second thermal liners 2100, 2100′ is greater than about 15% of the container volume.

In the embodiment shown, the thermal liner assembly 2000 is configurable into an operative configuration wherein the first and second thermal liners 2100, 2100′ are configured in the C-shaped configuration and are engaged with each other. When configured in the operative configuration, the thermal liner assembly 2000 defines a closed inner chamber 2002 delimited by a bottom wall 2004, four side walls 2006 and a top wall 2008. Each one of the bottom wall and the side walls of the thermal liner assembly 2000 is superposed respectively to the container bottom wall and the four container side walls of the container 2810 when the thermal liner assembly 2000 is inserted in the container 2810 with the inner chamber being closed at least by the top wall 2008 of the thermal liner assembly 2000.

For instance and referring to FIGS. 5 and 6, the first thermal liner 2100 of the thermal liner assembly 2000 is initially inserted in the container 2810, with the first end section 2120 lining the bottom of the container 2810 (i.e., the first end section 2120 being juxtaposed to the bottom wall of the container 2810), the central section 2110 lining one of the sides of the container 2810 (i.e., the central section being juxtaposed to one of the container side walls), and the second end section 2130 unfolded away from an entrance of an inner cavity of the container 2810 to allow access therein. Subsequently, the second thermal liner 2100′ of the thermal liner assembly 2000 is inserted in the container 2810, with each one of the sections lining a corresponding one of the sides of the container 2810 (i.e., each one of the sections being juxtaposed to one of the container side walls 2812). Finally, the second end section 2130 of the first thermal liner 2100 is folded to close the thermal liner assembly 2000 (i.e., to define the closed inner chamber) and the container flaps are closed over the second end section 2130 of the first thermal liner 2100 to close the container 2810 with the second end section 2130 lining the container flaps. One skilled in the art will understand that, in alternative embodiments (not shown), other insertion sequences can be performed in order to insert the above-described thermal liner assembly into the container where the first and second thermal liners 2100, 2100′ substantially lines the inner surface of the walls of the container.

One skilled in the art will understand that, as mentioned above, other panel assemblies or configuration thereof, different from the above-described assembly defining the thermal liner assembly 2000 of FIG. 6 can be foreseen in order to provide a thermal container. For instance, as represented in FIG. 8, it could be conceived a thermal container 3800 comprising a thermal liner assembly 3000 comprising first and second thermal liners 3100 as represented in FIG. 7.

It could also be conceived a thermal container comprising a thermal liner assembly made of a plurality of thermal liners 100, 1100 as represented in any one of FIGS. 1 to 3 and any combination of different embodiments of the thermal liner.

It is appreciated that the shape, the configuration, and the composition of the thermal container can vary from the embodiments shown.

### Examples

Tests were conducted on thermal liners according to the above-described embodiments, which includes the above-described characteristics and, as can be seen in the test results presented below, the thermal liner of the exemplary embodiments showed improved thermal properties.

The tests were conducted in an environment having a temperature of 27° C.; a thermal container was used, which comprised a substantially parallelepipedal container having a height of 15 in, a width of 11 in and a length of 13 in.

Four refrigerating gel packs of about 2 lb each having an initial temperature of about −18° C. were arranged in the container and a perishable good (for instance meat) was arranged in the container having an initial temperature of 4° C. Due to the proximity of the refrigerating gel packs, a temperature of the perishable good firstly decreases until about 0° C. A duration for the temperature of the perishable good to reach again 4° C. was measured in different configurations of the thermal container.

It has been noted that the duration of the different tested configurations is equal to or greater than a configuration wherein an inner panel would be enclosed in a fluid-tight manner in a single bag.

| | Duration for the |
|---|---|
| | temperature of |
| | the perishable |
| Configuration of the thermal liner assembly of the | good to reach |
| thermal container | again 4° C. |
| Thermal liner assembly comprising an inner | About 39 hours |
| member without inner and outer plies surrounding it | |
| Thermal liner assembly comprising an inner | About 44 hours |
| member surrounded by an inner ply (not | |
| represented) | |
| Thermal liner assembly comprising an inner | About 47 hours |
| member surrounded by inner and outer plies (as | |
| represented for instance in FIGS. 1, 2 and 5) | |
| Thermal liner assembly comprising an inner | About 47 hours |
| member surrounded by inner and outer plies and an | |
| additional and intermediate ply (as represented for | |
| instance in FIG. 3) | |
| Thermal liner assembly comprising an inner | About 47 hours |
| member surrounded by inner and outer plies and | |
| first and second additional and intermediate plies | |
| (not represented) | |
| Thermal liner assembly comprising an inner | About 51 hours |
| member surrounded by inner, intermediate and | |
| outer metalized plies (as represented for instance in | |
| FIGS. 7 and 8) | |

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A thermal liner comprising:
an inner member comprising two sheets and a core sandwiched between said two sheets, the core comprising a geometrically patterned structure extending transversally between said two sheets;
an inner ply covering at least partially the inner member; and
an outer ply extending outwardly and covering at least partially the inner ply;
wherein the outer ply is unattached to the inner ply at least along a section thereof so as to define therewith a ply-delimited air circulation gap inbetween.

2. The thermal liner according to claim 1, wherein each one of the inner and outer plies has a surface area, and wherein the surface area of the outer ply is greater than the surface area of the inner ply.

3. The thermal liner according to claim 1, wherein the inner ply forms an inner bag at least partially delimiting an inner member-containing cavity and wherein the outer ply forms an outer bag at least partially delimiting an inner bag-containing cavity.

4. The thermal liner according to claim 1, wherein at least one of the inner and outer plies comprises a cellulosic fiber-based sheet.

5. The thermal liner according to claim 1, wherein at least one of the inner and outer plies comprises at least one of liquid and vapor resistant barriers.

6. The thermal liner according to claim 1, wherein at least one of the inner and outer plies comprises a reflective surface.

7. The thermal liner according to claim 1, wherein said geometrically patterned structure is formed by cellulosic fiber-based walls extending transversally between said two sheets and wherein said geometrically patterned structure comprises a honeycomb structure defining a grid of polygonal open-ended core cells.

8. The thermal liner according to claim 1, wherein the thermal liner is configurable into a C-shaped configuration and is engageable with a similar thermal liner configured in the C-shaped configuration in order to define therewith an inner chamber.

9. The thermal liner according to claim 1, wherein the thermal liner comprises one or more additional and intermediate plies extending at least partially between the inner and outer plies.

10. The thermal liner according to claim 9, wherein at least one of said one or more additional and intermediate plies is spaced apart from at least one of the outer and inner plies at least along a section thereof so as to separate the ply-delimited air circulation gap into a plurality of additional air circulation gaps.

11. A thermal liner comprising:
an inner member having a volume Vp and comprising two sheets and a core sandwiched between said two sheets, the core comprising a geometrically patterned structure extending transversally between the two sheets;
an inner ply comprising a cellulosic fiber-based sheet and covering at least partially the inner member and delimiting a volume Vi to contain the inner member; and
an outer ply comprising a cellulosic fiber-based sheet and covering at least partially the inner ply and delimiting a volume Vo to contain the inner member surrounded by the inner ply;
wherein the volume Vo is greater than the volume Vi and the volume Vi is greater than the volume Vp to provide an inner air circulation gap between the inner member and the inner ply and a ply-delimited air circulation gap between the inner ply and the outer ply.

12. The thermal liner according to claim 11, wherein the inner ply forms an inner bag at least partially delimiting an inner member-containing cavity and wherein the outer ply forms an outer bag at least partially delimiting an inner bag-containing cavity.

13. The thermal liner according to claim 11, wherein at least one of the inner and outer plies comprises at least one of liquid and vapor resistant barriers and a reflective surface.

14. The thermal liner according to claim 11, wherein said geometrically patterned structure is formed by cellulosic fiber-based walls extending transversally between the two sheets and comprises a honeycomb structure defining a grid of polygonal open-ended core cells.

15. The thermal liner according to claim 11, wherein the thermal liner comprises one or more additional and intermediate plies extending at least partially between the inner and outer plies, wherein at least one of said one or more additional and intermediate plies is spaced apart from at least one of the outer and inner plies at least along a section thereof so as to separate the ply-delimited air circulation gap into a plurality of additional air circulation gaps.

16. A thermal container comprising:
a container comprising:
a container bottom wall; and
four container side walls extending substantially perpendicularly from the container bottom wall; and
a thermal liner assembly insertable into the container and comprising at least one thermal liner comprising:
an inner member comprising two sheets and a core sandwiched between said two sheets, the core comprising a geometrically patterned structure extending transversally between said two sheets;
an inner ply covering at least partially the inner member; and
an outer ply covering at least partially the inner ply;
wherein at least one of the inner and outer plies comprises a cellulosic fiber-based sheet;
wherein the outer ply is spaced apart from the inner ply at least along a section thereof so as to define therewith a ply-delimited air circulation gap inbetween;
wherein the thermal liner assembly is configurable into an operative configuration defining an inner chamber delimited by a bottom wall, four side walls and a top wall; and
wherein each one of the bottom wall and the side walls of the thermal liner assembly is superposed respectively to the container bottom wall and the four container side walls when the thermal liner assembly is inserted in the container with the inner chamber being closeable at least by the top wall of the thermal liner assembly.

17. The thermal container according to claim 16, wherein at least one of the inner and outer plies of said at least one thermal liner comprises at least one of liquid and vapor resistant barriers and a reflective surface.

18. The thermal container according to claim 16, wherein said geometrically patterned structure of said at least one thermal liner is formed by cellulosic fiber-based walls extending transversally between said two sheets and comprises a honeycomb structure defining a grid of polygonal open-ended core cells.

19. The thermal container according to claim 16, wherein said at least one thermal liner comprises one or more additional and intermediate plies extending at least partially between the inner and outer plies, wherein at least one of said one or more additional and intermediate plies is spaced apart from at least one of the outer and inner plies at least along a section thereof so as to separate the ply-delimited air circulation gap into a plurality of additional air circulation gaps.

20. The thermal container according to claim 16, wherein the thermal liner assembly comprises first and second thermal liners engageable with each other in order to define together the inner chamber when the thermal liner assembly is configured into the operative configuration, and wherein the first and second thermal liners are configurable into a C-shaped configuration and are engageable with each other when in the C-shaped configuration in order to define together the inner chamber.
